(19) United States
(12) Patent Application Publication
(10) Pub. No.: US 2025/0284633 A1
(43) Pub. Date: Sep. 11, 2025

(54) MEMORY DEVICE WITH DUAL LOGIC INTERFACES AND INTERNAL DATA MOVER

(71) Applicant: Micron Technology, Inc., Boise, ID (US)

(72) Inventor: David Andrew Roberts, Wellesley, MA (US)

(21) Appl. No.: 19/060,360

(22) Filed: Feb. 21, 2025

Related U.S. Application Data
(60) Provisional application No. 63/563,112, filed on Mar. 8, 2024.

(51) Int. Cl. G06F 12/02; G06F 12/0831; G06F 13/42

(52) U.S. Cl. CPC G06F 12/0246; G06F 12/0835; G06F 13/4282

(57) ABSTRACT

A data mover in a memory device receives a base address for a physical memory region. The data mover determines that a cache line in the physical memory region is in a modified state and determines a second address in a storage region of the memory device using a lookup table stored in the data mover. The data mover then stores the modified cache line and metadata associated with the modified cache line at the second address in the storage region. The data mover upon receiving a synchronization request from a host processor, and upon determining that the cache line is in the modified state, updates the modified cache line and metadata associated with the modified cache line in the storage region of the memory device. The data mover includes a direct memory access (DMA) controller.

### RELATED APPLICATIONS

This application claims the benefit of U.S. Provisional Application No. 63/563,112, filed Mar. 8, 2024, the entirety of which is hereby incorporated by reference herein.

### TECHNICAL FIELD

Embodiments of the disclosure relate generally to memory sub-systems, and more specifically, relate to a memory sub-system with dual logic interfaces and an internal data mover.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing environment that includes a memory sub-system in accordance with some embodiments of the present disclosure.

FIG. 2 is a block diagram of an example system including a compute express link (CXL) device in accordance with some embodiments of the present disclosure.

FIG. 3 is a flow diagram of an example method to move data between a memory region and a storage region of a memory device, in accordance with some embodiments of the present disclosure.

FIG. 4 is a flow diagram of an example method to move data between a memory region and a storage region of a memory device, in accordance with some embodiments of the present disclosure.

FIG. 5 is a block diagram of an example computer system in which embodiments of the present disclosure may operate.

### DETAILED DESCRIPTION

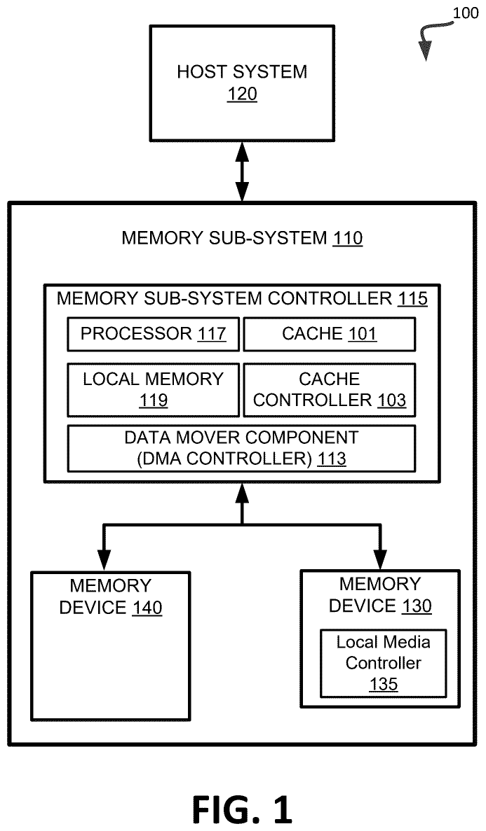

Aspects of the present disclosure are directed to a memory device with a dual logic interface and an internal data mover. A memory sub-system can be a storage device, a memory module, or a combination of a storage device and memory module. Examples of storage devices and memory modules are described below in conjunction with FIG. 1. In general, a host system can utilize a memory sub-system that includes one or more memory components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can have a row of associated memory cells in a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes.

In a conventional memory sub-system, a host processor is coupled to a memory region (e.g., dynamic random-access memory (DRAM)) of the memory device using a first interface (e.g., double data rate (DDR) protocol) and coupled to a storage region (e.g., solid state drive (SSD)) of the memory device using another interface (e.g., PCIE or non-PCIE protocols), and so any data transfer between the memory region and the storage region is a two step process where data from the memory is transferred to the host and the host then transfers the data to the storage. This two-step process may cause latency in the memory device, may result in lower bandwidth, and therefore increase power consumption of the memory device.

Aspects of the present disclosure address the above and other deficiencies by having a memory sub-system with a dual logic interface and an internal data mover. In some embodiments, a host system may allocate a page cache for storage into a DRAM address range within the same memory module. When performing page cache operations, the host system first checks whether or not the source and destination page cache and the storage block addresses are inside the same memory module. If so, the host system invokes a copy command to trigger internal data mover transfers instead of external host-side direct memory access (DMA) transfers. In multi-module systems, (e.g., via a CXL switch) the data mover could be placed in a switch and have copy requests delegated to it in a similar way (e.g., to transfer between separate DRAM and SSD modules) behind the switch. This reduces or eliminates copy traffic from the host-switch links.

The data mover (e.g., direct memory access (DMA) controller) in a memory sub-system receives a list of block base addresses and sizes for a physical memory region (one or more Operating System pages). The data mover determines that a page in the physical memory region is in a dirty (modified) state and determines a second address in a storage region of the memory device using a destination address it receives from the host along with each source block address. Alternatively, the second address can be determined by using a lookup table stored in the data mover. The data mover then stores the modified page and metadata associated with the modified cache line at the second address in the storage region. The data mover, upon receiving a synchronization request from a host processor, and upon determining that the page is in the dirtystate, updates the modified page and metadata associated with the dirtypage in the storage region of the memory device. Before updating the page in storage, coherence requests (such as writeback-invalidate or back-invalidate) can be issued to the host ensuring that any locally cached modified portions of the pages are written back to the first memory page in the first region before being copied to the second memory page in the second region.

Advantages of the present disclosure include, but are not limited to, performance improvements in the memory sub-system. For example, if internal bandwidth is greater than the external bandwidth of the memory module, the disclosed embodiments result in faster copy operations. Additionally, since the memory and storage share a dual logic interface, lower energy or lower input/output power is used by the memory sub-system because the components are physically close to each other. Furthermore, because the data mover is provided within the memory sub-system, it reduces congestion on the host to memory and host to storage links and reduces traffic to/from the memory modules.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM), synchronous dynamic random access memory (SDRAM), a ferroelectric random access memory (FeRAM), a magnetic random access memory (MRAM), and a resistive random access memory (RRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks. Some types of memory, such as 3D cross-point, can group pages across dice and channels to form management units (MUs).

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical MU address, physical block address) that are associated with the memory devices 130. For instance, the memory sub-system controller 115 can include a cache 101 and a cache controller 103. For example, cache 101 can be SRAM. Memory sub-system can be configured such that memory device 130 and/or 140 can be memory mapped storage for the memory sub-system 110. Memory sub-system 110 can be configured to include cache memory for caching data stored in the memory mapped stored of the memory sub-system 110. Memory device 130, memory device 140, and/or cache 101 can be configured as cache memory for the memory sub-system 110. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130. The memory device (e.g., DRAM or FeRAM device) may include multiple memory banks, which are grouped in bank groups. Each memory bank is a memory array that includes a plurality of memory cells, such that each memory cell is capable of storing, depending on the memory cell type, one or more bits of information.

As noted herein above, the memory device 130 may further include a set of row buffers, which may be utilized for storing the data retrieved from a row of a bank. The memory device may further include an on-die cache, which may be utilized for caching portions of the data stored in the main memory banks. In an illustrative example, the data that has been read from a memory bank into a row buffer may be also cached by the on-die cache, which thus may be utilized for servicing subsequent memory access requests that are directed to the same row. In some implementations, the cache line size of the on-die cache may match the row buffer size, thus simplifying the cache line allocation schemes that may be employed for managing the cache.

Various other components, such as sense amplifiers, input/output interfaces, and command interfaces are omitted from FIG. 1 for clarity and conciseness. In one embodiment, the memory device 130 may be implemented as one or more integrated circuits located on one or more dies. In another embodiment, the memory sub-system 110 may be implemented as a System-on-Chip, which, in addition to the memory device 130 and memory sub-system controller 115 of FIG. 1, may include one or more processing cores and one or more input/output (I/O) interfaces.

In some implementations, management of the cache may be performed by circuitry that is disposed on the memory device 130. Alternatively, management of the cache may be performed by circuitry that is disposed outside of the memory device 130, such as by processor 117. The cache management policy implemented by the memory device 130, by the system-on-chip, or by the host may include caching rules specifying what data should be cached and eviction rules specifying which cache line should be evicted when no cache lines are available to store new data. In some implementations, the baseline caching rule may specify caching any new incoming data. Furthermore, one or more caching rules may implement certain heuristics with respect to which data should be cached (or excluded from caching). Such heuristic rules may specify logical conditions evaluating the data patterns, address ranges, etc. In an illustrative example, a caching rule may specify one or more memory address ranges which should be cached. In another illustrative example, a caching rule may specify one or more memory address ranges which should be excluded from caching. In yet another illustrative example, a caching rule may specify a data pattern such that the incoming data that matches the pattern should be cached. In yet another illustrative example, a caching rule may specify a data pattern such that the incoming data that matches the pattern should be excluded from caching.

The cache management policy may further include one or more eviction rules. In various illustrative examples, an eviction rule may specify the cache line that should be evicted when no cache lines are available to store the new data (e.g., first in first out (FIFO), last in first out (LIFO), least recently used, least frequently used, random replacement, etc.). In some implementations, cache eviction rules may specify logical conditions evaluating the data patterns, address ranges, etc.

As noted herein above, each line of the cache may be associated with cache line metadata specifying the memory address (e.g., the bank group identifier, the memory bank identifier, and the row address), the content of which is currently stored in the cache line. In some implementations, the cache line metadata associated with each line of the cache may further include a cache line status flag indicating whether the cache line may have been modified (to one of a MESIF state (modified, exclusive, shared, invalid, and forward) or a state according to the cache coherency protocol of the host system) since it was copied from the main memory. Accordingly, the data stored in the cache line may only be written back to the main memory if the cache line status flag indicates that the cache line may have been modified since it was copied from the main memory. Conversely, unmodified data in the cache line may be discarded upon the cache line eviction.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

In some embodiments, the interface between the host system 120 and the memory sub-system 110 can implement one or more alternate protocols supported by another interface standard. For example, the interface can implement one or more alternate protocols supported by PCIe (e.g., non-PCIe protocols). In some embodiments, the interface can be represented by the compute express link (CXL) interface or any communication link that allows cache line granularity updates and shares coherency control with the processor 117.

A CXL system is a cache-coherent interconnect for processors, memory expansion, and accelerators. A CXL system maintains memory coherency between the CPU memory space and memory on attached devices, which allows resource sharing for higher performance, reduced software stack complexity, and lower overall system cost.

The CXL interface can support a number of protocols that can run on top of PCIe, including a CXL.io protocol, a CXL.mem protocol, and a CXL.cache protocol. The CXL.io protocol is a PCIe-like protocol that can viewed as an “enhanced” PCIe protocol capable of carving out managed memory. CXL.io can be used for initialization, link-up, device discovery, and enumeration, register access, and can provide an interface for I/O devices. The CXL.mem protocol can enable host access to the memory of an attached device using memory semantics (e.g., load and store commands). This approach can support both volatile and persistent memory architectures. The CXL.cache protocol can define host-device interactions to enable efficient caching of host memory with low latency using a request and response approach. Traffic (e.g., NVMe traffic) can run through the CXL.io protocol, and the CXL.mem and CXL.cache protocols can share a common link layer and transaction layer. Accordingly, the CXL protocols can be multiplexed and transported via a PCIe physical layer.

The memory sub-system 110 can include a data mover component 113. Although not shown in FIG. 1 so as to not obfuscate the drawings, the data mover component 113 can include various circuitry to facilitate prefetch triggering for the memory sub-system and/or the components of the memory sub-system. In some embodiments, the data mover component 113 can include special purpose circuitry in the form of an ASIC, FPGA, state machine, and/or other logic circuitry that can allow the data mover component 113 to orchestrate and/or perform operations to selectively trigger data mover for the memory device 130 and/or the memory device 140 based on logic inside a controller of the memory device tracking addresses and determining to push data into cache controller 103 and/or the cache controller 103 including prefetch logic and sending messages to the memory device 130 to a monitoring engine in the memory device 130 causing the memory device 130 to move the data. In some instances, a monitoring engine may be located in one or more cache controllers 103.

In some embodiments, the memory sub-system controller 115 includes at least a portion of the data mover component 113. For example, the memory sub-system controller 115 can include a processor 117 (processing device) configured to execute instructions stored in local memory 119 for performing the operations described herein. In some embodiments, the data mover component 113 is part of the host system 110, an application, or an operating system.

In a non-limiting example, an apparatus (e.g., the computing system 100) can include a memory sub-system data mover component 113. The memory sub-system data mover component 113 can be resident on the memory sub-system 110. As used herein, the term “resident on” refers to something that is physically located on a particular component. For example, the memory sub-system data mover component 113 being “resident on” the memory sub-system 110 refers to a condition in which the hardware circuitry that comprises the memory sub-system data mover component 113 is physically located on the memory sub-system 110. The term “resident on” can be used interchangeably with other terms such as “deployed on” or “located on,” herein.

The memory sub-system data mover component 113 can be configured to determine when to perform a prefetch operation and determine which cache device of a plurality of cache devices to send a prefetch command. A DMA controller can be configured to send the prefetched data to a cache controller 103 of the determined cache device 101. As described above, the memory components can be memory dice or memory packages that form at least a portion of the memory device 130.

The memory sub-system data mover component 113 can be further configured to track source addresses accessed by the cache controller and detect source address access patterns based on the tracked source addresses. For example, commands can be sent to the memory device (e.g., via a number of cache controllers) for a prefetch operation. A DMA controller can send data to any one of a number of cache devices coupled to a memory device that includes the DMA controller.

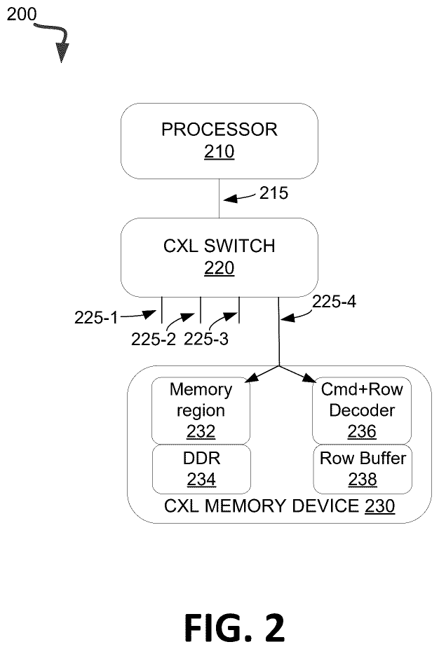

FIG. 2 is a block diagram of an example system 200 including a data mover within a CXL switch 220 in accordance with some embodiments of the present disclosure. More specifically, in this illustrative example, the system 200 includes a compute express link (CXL) memory device 230, which may correspond to the memory device 130 shown in FIG. 1.

The system 200 can include a processor (e.g., a central processing unit (CPU)) 210. The processor may correspond to processor 117 shown in FIG. 1. The system 200 can optionally include a CXL switch 220 coupled to the processor 210 via a CXL connection 215 or a communication link that allows cache line granularity updates and shares coherency control with the processing device. The first CXL connection 215 can include a set of data-transmission lanes (“lanes”) for implementing CXL protocols, including CXL.io, CXL.mem, and CXL.cache. The first CXL connection 215 can include any suitable number of lanes in accordance with the embodiments described herein. In some embodiments, the first CXL connection 215 can include 16 lanes (i.e., CXL ×16).

The system 200 can further include a number of CXL connections 225-1 through 225-4, and a CXL memory device 230 operatively coupled to the CXL switch via one of the second CXL connections 225-1 through 225-4. In this illustrative example, the CXL memory device 230 is operatively coupled to the CXL switch 220 via the second CXL connection 225-4. Each of the second CXL connections 225-1 through 225-4 can include a corresponding set of lanes each including any suitable number of lanes in accordance with the embodiments described herein, and each of the CXL connections 225-1 through 225-4 may be coupled to additional CXL devices (not shown). In some embodiments, the second CXL connection 225-4 can include 4 lanes (CXL ×4).

In this illustrative example, the CXL memory device 230 is a dynamic random access memory (DRAM), a synchronous dynamic random access memory (SDRAM), a ferroelectric random access memory (FeRAM), a magnetic random access memory (MRAM), or a resistive random access memory (RRAM) including a number of sub-components. More specifically, the sub-components include a memory region 232, a DDR memory 234 (e.g., memory device 130), a command and row decoder 236, and a row buffer 238. The CXL memory device 230 can provide support for at least CXL.io and CXL.mem. More specifically, the memory region 232 can be accessible over CXL.mem and CXL.io.

Using the configuration shown in FIG. 2, the CXL memory device 230 can include, e.g., PCIe with CXL.io protocol and CXL.mem protocol support. More specifically, the CXL device memory 230 can allocate a segment of memory for the memory region 232 that will be visible through CXL.mem. For example, the memory region 232 can have a size of 32 MB. However, such a size is purely exemplary. This segment of memory corresponding to the memory region 232 can then be marked as shareable and cacheable.

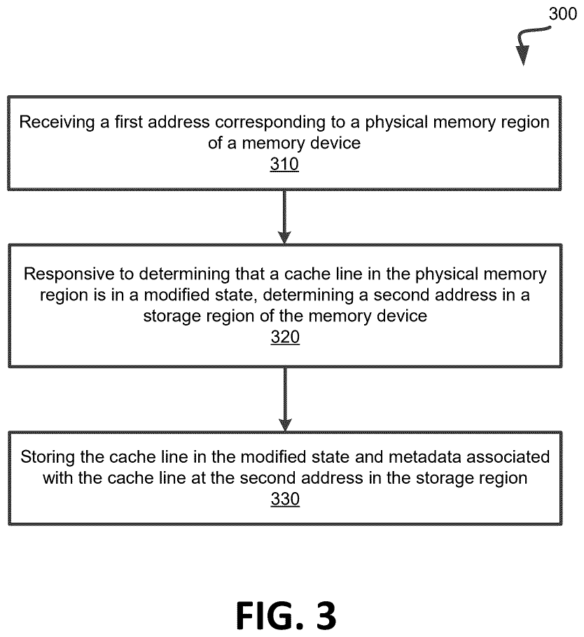

FIG. 3 is a flow diagram of an example method 300 to move data between a memory region and a storage region of a memory device, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the data mover component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

Initially, a host system may allocate page cache for storage into an address range of a memory region (e.g., memory device 140) within a memory sub-system (e.g., memory sub-system 110). When performing page cache operations, the host system first checks whether or not the source and destination page cache and the storage block addresses are inside the same memory sub-system. If so, the host system invokes a copy command to trigger internal data mover transfers instead of external DMA transfers. In multi-module systems, (e.g., via a CXL switch) the data mover could be placed in a switch and have copy requests delegated to it in a similar way (e.g., to transfer between separate DRAM and SSD modules) behind the switch.

The term “delta” as used in this disclosure refers to a difference, in data or content, between a current state and a previous state of a memory region. More specifically, the term “delta” refers to a difference, in data or content, between a modified state and a state of a cache line prior to the modified state, according to the MESI or MESIF protocol. A “cache line,” as used in this disclosure, may refer to a sequence of memory bytes with a particular alignment and length. In CXL systems, for example, the alignment and length constraints may be 64 bytes. While this term is sometimes used to refer to just the associated sequence of bytes in a processor cache, for purposes of this disclosure, it refers to the actual memory bytes.

A “cache line state,” as used in this disclosure, refers to information characterizing the content of the cache line from the cache coherence perspective. A cache line state can be a subset of the system's MESIF (modified, exclusive, shared, invalid, and forward) states and can be reflected by a single Boolean value (e.g., the cache line status flag) indicating whether the cache line may have been modified (e.g., to one of a MESIF state or a state according to the cache coherency protocol of the host system) since it was copied from the main memory.

A log memory buffer is a region of memory containing the state information and a sequence of data entries. The state information includes a log memory buffer status flag declaring the buffer as full or not full and a pointer to the “next” memory buffer. The data entries can hold cache line metadata (e.g., the address of the content of the cache line within the memory device) and cache line content as well. For example, the memory device receives a list of empty log memory buffers associated with a delta logging session.

In some embodiments, page caches for caching storage blocks may be software-managed and may use operating system pages as the mapping and transfer granularity. For example, for x86 processors, these are usually, 4 KB, 2 MB, or 1 GB in size, which are configurable. The pages include a “dirty” bit, which indicates changed data similar to the cache line Modified state. Current DMA engines can request write-back of modified data in host caches to ensure a page being moved includes all cache line changes before the main memory page is moved. In some embodiments with a cache coherent protocol like CXL, a remote, memory-side data mover can request that the host system write back any “dirty” data before the data mover moves data. Such a CXL command is generally referred to as “back-invalidate.”

According to one embodiment, a CXL-attached memory device may receive one or more CXL protocol messages from a host processor. The CXL protocol messages include cache line state messages and cache line update messages. The memory device may track the cache line state, for example modified state, for all cache lines it contains. The CXL memory device may also accept non-CXL commands to expose the cache line delta logging functionality.

The MESI protocol is an Invalidate-based cache coherence protocol that supports write-back caches. The letters in the acronym MESI represent four exclusive states that a cache line can be marked with. In the modified (M) state, the cache line is present only in the current cache, and is dirty, it may have been modified (M) state from the value in main memory. The cache is required to write the data back to main memory at some time in the future, before permitting any other read of the (no longer valid) main memory state. The write-back changes the line to the shared(S) state. In the exclusive (E) state, the cache line is present only in the current cache but is clean—it matches main memory. It may be changed to the shared state at any time, in response to a read request. Alternatively, it may be changed to the modified state when writing to it. A shared(S) state indicates that this cache line may be stored in other caches of the machine and is clean, it matches the main memory. The line may be discarded (changed to the Invalid state) at any time. An invalid (I) state indicates that this cache line is invalid (unused). When the block is marked M (modified) or E (exclusive), the copies of the block in other caches are marked as I (Invalid).

The MESIF protocol is a cache coherency and memory coherence protocol including five states, Modified (M), Exclusive (E), Shared(S), Invalid (I) and Forward (F). Here, the M, E, S and I states are the same as in the MESI protocol. The F state is a specialized form of the S state, and indicates that a cache should act as a designated responder for any requests for the given line. The protocol ensures that, if any cache holds a line in the S state, at most one (other) cache holds it in the F state. In a system of caches employing the MESIF protocol, a cache line request will be responded to only by the cache holding the line in the F state. This allows the requestor to receive a copy at cache-to-cache speeds, while allowing the use of as few multicast packets as the network topology may allow.

Because a cache may unilaterally discard (invalidate) a line in the S or F states, it is possible that no cache has a copy in the F state, even though copies in the S state exist. In this case, a request for the line is satisfied (less efficiently, but still correctly) from main memory. To minimize the chance of the F line being discarded due to lack of interest, the most recent requestor of a line is assigned the F state, when a cache in the F state responds, it gives up the F state to the new cache.

Thus, one difference from the MESI protocol is that a request for a copy of the cache line for read always enters the cache in the F state. The only way to enter the S state is to satisfy a read request from main memory. There are other techniques for satisfying read requests from shared caches while suppressing redundant replies, but having only a single designated cache response makes it easier to invalidate all copies when necessary to transition to the exclusive state.

At operation 310, a processing device (e.g., processor 117) in a memory device (e.g., memory sub-system 110) receives a base address for a physical memory region (e.g., in memory device 140). At operation 320, the processor scans or reads the address in the memory region and determines that a cache line in the physical memory region is in a modified state. The processor then accesses a look up table stored and maintained in the memory sub-system (e.g., by a DMA controller), and finds an address in a storage region (e.g., memory device 130) of the memory device that corresponds to the base address. The look up table may be synchronized with the look up table maintained by the host system. In some embodiments, the processing device may implement a flash translation layer (FTL) to store and update the look up table. The FTL may manage the mapping of logical block addresses to the physical block addresses on the memory device. However, for firmware (e.g., operating system) managed page caches, the “dirty” state of a page is a separate mechanism to the host SRAM caches. For example, a file in storage device 130 is “memory-mapped” to a main memory address range, which is write-protected in the system page table. A first read or write to one of these pages causes a software interrupt, invoking the operating system. An empty page is allocated by the operating system in page cache device 140. The data mover copies the page from device 130 to device 140 and sets the page table attribute to present (and dirty, if triggered by a write). In the conventional system, the internal data mover does the copy. In the present embodiment, the device internal data mover performs the copy function. Meanwhile, the host SRAM caches can cache parts of those page cache pages in device 140. The host SRAM caches have their own tracking state (e.g., MOESI, etc.), and before a copy operation is performed, the data mover or host DMA engine requests for those caches to write back any changes, using either the coherent memory bus (e.g., CXL) or on-chip bus, respectively.

At operation 330, the processing device stores the modified cache line and metadata associated with the modified cache line at the second address in the storage region (e.g., memory device 130). The processing device upon receiving a synchronization request from the host processor may determine that the cache line is in a modified state, and update the modified cache line and metadata associated with the modified cache line in the storage region of the memory device (e.g., memory device 130). In some embodiments, the metadata may include a cache line status flag indicating whether the cache line is in a modified state and/or a memory address of the modified cache line. In some embodiments, the processing device is a direct memory access (DMA) controller of the memory sub-system.

Upon completion of the copy operation or upon satisfying the synchronization request, the processing device may send a status message to the host processor. The status message may include a completion status and/or a session identifier of the delta logging session. Additionally, the processing device may store and maintain a list including all memory addresses associated with one or more modified cache lines, and the list may be visible to the host processor. As discussed in above embodiments, the memory device may include a computer express link (CXL) device and the processing device may be a direct memory access (DMA) controller of the memory sub-system. In some embodiments, the CXL device may include a dynamic random access memory (DRAM), a synchronous dynamic random access memory (SDRAM), a ferroelectric random access memory (FeRAM), a magnetic random access memory (MRAM), or a resistive random access memory (RRAM). In some embodiments, the processing device may be coupled to the host processor, and an interface between the host processor and the processing device may include a compute express link (CXL) (e.g., as shown in FIG. 2) or a communication link that allows cache line granularity updates and shares coherency control with the processing device.

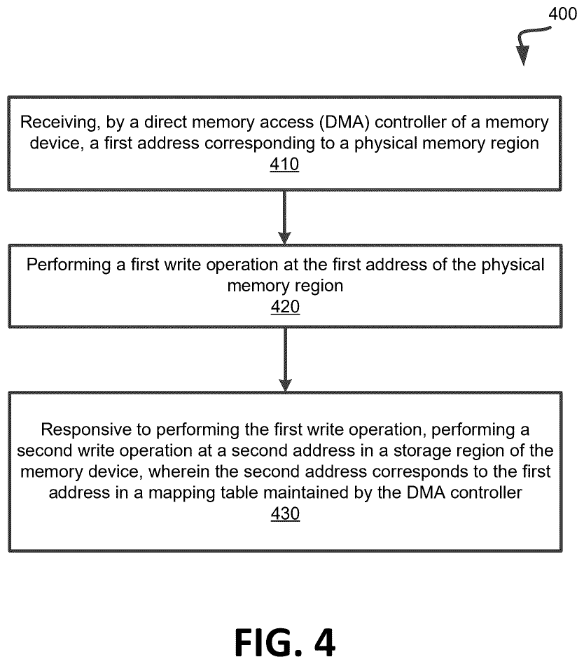

FIG. 4 is a flow diagram of an example method 400 to move data between a memory region and a storage region of a memory device, in accordance with some embodiments of the present disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by the data mover component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 410, the processing device may receive a write request from the host system (e.g., host system 120). The write request may include an address in a physical memory region (e.g., memory device 140). At operation 420, the processing device may perform a write operation at the given address of the physical memory region. Alternatively, or in addition, the processing device may perform a read or scan operation at the address, depending on the type of request received from the host system. Upon completing the write operation in the physical memory region, at operation 430, the processing device may perform a second write operation at an address in a storage region (e.g., memory device 130) of the memory device. The new address may correspond to the first address in a mapping table maintained by a DMA controller in the memory sub-system. In a further action, the processing device may receive a “copy” command from the host processor. In response, the processing device may scan the first address to see if there has been a modification, and if there has been a modification, the processing device may copy data from the first address to the address in the storage region.

Upon completion of the copy operation or upon satisfying the synchronization request, the processing device may send a status message to the host processor. The status message may include a completion status and/or a session identifier of the delta logging session. Additionally, the processing device may store and maintain a list including all memory addresses associated with one or more modified cache lines, and the list may be visible to the host processor. As discussed in above embodiments, the memory device may include a computer express link (CXL) device and the processing device may be a direct memory access (DMA) controller of the memory sub-system. In some embodiments, the CXL device may include a dynamic random access memory (DRAM), a synchronous dynamic random access memory (SDRAM), a ferroelectric random access memory (FeRAM), a magnetic random access memory (MRAM), or a resistive random access memory (RRAM). In some embodiments, the processing device may be coupled to the host processor, and an interface between the host processor and the processing device may include a compute express link (CXL) (e.g., as shown in FIG. 2) or a communication link that allows cache line granularity updates and shares coherency control with the processing device.

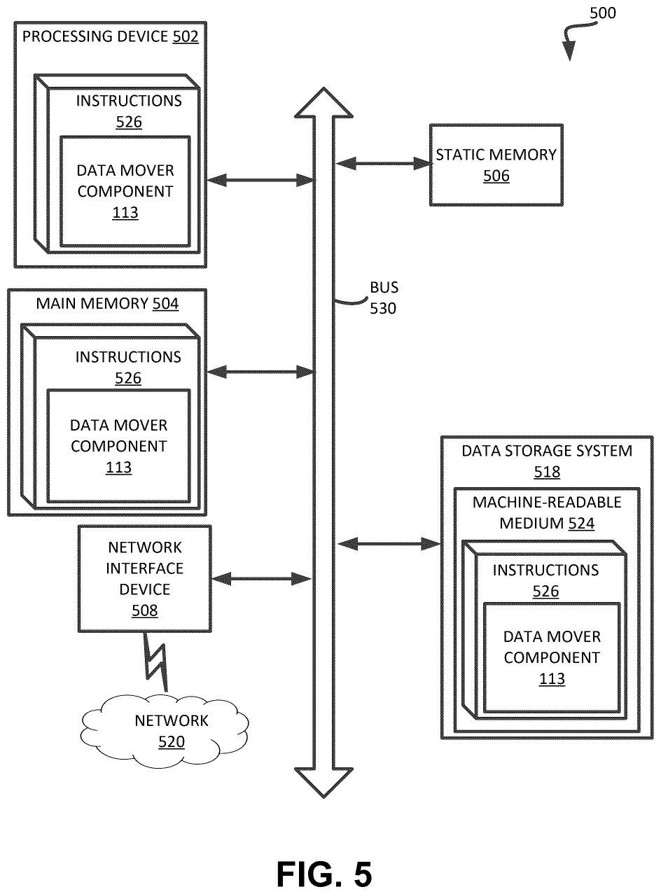

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the data mover component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a data mover component (e.g., the data mover component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
receiving a first address corresponding to a physical memory region of the memory device;
responsive to determining that a cache line in the physical memory region is in a modified state, determining a second address in a storage region of the memory device; and
storing the cache line in the modified state and metadata associated with the cache line at the second address in the storage region.

2. The system of claim 1, wherein determining the second address further comprises looking up an address corresponding to the first address in a lookup table stored in a direct memory access (DMA) controller of the system.

3. The system of claim 1, wherein the operations further comprise:
receiving a synchronization request from a host processor;
scanning the first address of the physical memory region; and
responsive to determining that the cache line is in a further modified state, updating the cache line and metadata associated with the cache line in the storage region of the memory device.

4. The system of claim 1, wherein the operations further comprise:
sending a status message to a host processor, the status message comprising at least one of a completion status or a session identifier of a logging session.

5. The system of claim 1, wherein the metadata comprises a cache line status flag indicating whether the cache line is in a modified state and a memory address of the cache line.

6. The system of claim 1, wherein the operations further comprise:
storing a list comprising memory addresses associated with one or more modified cache lines, wherein the list is visible to a host processor.

7. The system of claim 1, wherein the memory device comprises a computer express link (CXL) device and wherein the processing device is a direct memory access (DMA) controller of the system.

8. The system of claim 7, wherein the CXL device comprises one of a dynamic random access memory (DRAM), a synchronous dynamic random access memory (SDRAM), a ferroelectric random access memory (FeRAM), a magnetic random access memory (MRAM), and a resistive random access memory (RRAM).

9. The system of claim 1, wherein the processing device is operatively coupled to a host processor, and an interface between the host processor and the processing device comprises a compute express link (CXL) or a communication link that allows cache line granularity updates and shares coherency control with the processing device.

10. A method comprising:
receiving, by a direct memory access (DMA) controller of a memory sub-system, a first address corresponding to a physical memory region of a memory device;
performing a first write operation at the first address of the physical memory region; and
responsive to performing the first write operation, performing a second write operation at a second address in a storage region of the memory device, wherein the second address corresponds to the first address in a mapping table maintained by the DMA controller.

11. The method of claim 10, further comprising:
receiving a copy command from a host processor;
responsive to receiving the copy command, scanning the first address; and
responsive to determining that data in the first address is in a modified state, copying the data from the first address to the second address.

12. The method of claim 10, further comprising:
sending a status message to a host system, the status message comprising at least one of a completion status or a session identifier of a logging session.

13. The method of claim 10, wherein performing the second write operation further comprises writing a cache line status flag indicating whether the cache line is in a modified state and a memory address of the cache line.

14. The method of claim 13, further comprising:
storing a list comprising memory addresses associated with one or more modified cache lines, wherein the list is visible to a host processor.

15. A non-transitory computer-readable storage medium comprising instructions that, when executed by a processing device, cause the processing device to perform operations comprising:
receiving a first address corresponding to a physical memory region of a memory device; and
responsive to determining that a cache line in the physical memory region is in a modified state, determining a second address in a storage region of the memory device; and
storing the cache line in the modified state and metadata associated with the cache line at the second address in the storage region.

16. The non-transitory computer-readable storage medium of claim 15, the operations further comprising:
receiving a synchronization request from a host processor;
scanning the first address of the physical memory region; and
responsive to determining that the cache line is in a further modified state, updating the cache line and metadata associated with the cache line in the storage region of the memory device.

17. The non-transitory computer-readable storage medium of claim 15, the operations further comprising:
sending a status message to a host processor, the status message comprising at least one of a completion status or a session identifier of a logging session.

18. The non-transitory computer-readable storage medium of claim 15, wherein the metadata comprises a cache line status flag indicating whether the cache line is in a modified state and a memory address of the cache line.

19. The non-transitory computer-readable storage medium of claim 15, wherein the operations further comprise:
storing a list comprising memory addresses associated with one or more modified cache lines, wherein the list is visible to a host processor.

20. The non-transitory computer-readable storage medium of claim 15, wherein the processing device comprises a direct memory access (DMA) controller, and the memory device comprises a CXL device comprising one of a dynamic random access memory (DRAM), a synchronous dynamic random access memory (SDRAM), a ferroelectric random access memory (FeRAM), a magnetic random access memory (MRAM), and a resistive random access memory (RRAM).
